(19) United States
(12) Patent Application Publication
(10) Pub. No.: US 2008/0292886 A1
(43) Pub. Date: Nov. 27, 2008

(54) ADHESIVE FORMULATIONS CONTAINING UREA ADDITIVES, METHODS OF FORMING PLYWOOD THEREWITH, AND PLYWOOD PRODUCTS MADE THEREBY

(75) Inventors: Anthony J. Allen, Wilmington, DE (US); Richard J. Riehle, Wilmington, DE (US); Joseph Marcinko, Mantua, NJ (US)

Correspondence Address: HERCULES INCORPORATED, 1313 N. MARKET STREET, WILMINGTON, DE, 19894-0001, US

(73) Assignee: Hercules Inc., Wilmington, DE (US)

(21) Appl. No.: 12/051,470

(22) Filed: Mar. 19, 2008

Related U.S. Application Data
(60) Provisional application No. 60/896,614, filed on Mar. 23, 2007.

(51) Int. Cl. C09J 101/02; C08K 5/21; B32B 27/34; B32B 27/18; C08L 1/02

(52) U.S. Cl. 428/423.1; 524/211; 524/35; 428/474.4; 156/328

(57) ABSTRACT

Compositions suitable for use as wood adhesives are described, which compositions comprise: (a) a polymeric component selected from the group consisting of lignins, proteins, and mixtures thereof, (b) an adhesion promoter comprising at least one component selected from the group consisting of (i) adducts of an epoxide and a resin selected from the group consisting of polyamine resins, polyamidoamine resins, polyamide resins, and combinations thereof, and (ii) combinations of a curing agent and a compound having at least one amine, amide, imine, imide, or nitrogen-containing heterocyclic functional group capable of reacting with at least one functional group of the polymeric component; and (c) an additive selected from the group consisting of urea, N-substituted ureas, N,N-disubstituted ureas, N,N′-disubstituted ureas, N,N,N′-trisubstituted ureas, N,N,N′,N′-tetrasubstituted ureas, urea derivatives, and mixtures thereof.

### CROSS-REFERENCE TO RELATED APPLICATIONS

This application claims priority under 35 U.S.C. §119(e) of U.S. provisional patent application Ser. No. 60/896,614, filed on Mar. 23, 2007, the entire contents of which are hereby incorporated by reference.

### BACKGROUND OF THE INVENTION

Composite and laminate wood-based products are widely used throughout the world in construction projects, both commercial and residential. Composite wood products are generally formed by providing a mixture of small dimension pieces of cellulosic material, which can be fragmented from solid wood into strands, fibers, and/or chips (often referred to collectively as “wood particles”), and an adhesive composition, and subsequently the mixture is subjected to heat and pressure to produce a composite wood sheet such as particle board, wafer board or oriented strand board. Laminate wood products, such as plywood, are usually prepared by adhering a higher quality or hardwood surface veneer layer to a core substrate which can consist of a composite structure as previously described or several layers of a lower quality wood, wherein the outer quality surface veneer layers are bonded to the core substrate using an adhesive.

The most commonly used adhesives in the composite and laminate wood industry have been phenol-formaldehyde resins (PF) and urea-formaldehyde resins (UF). However, there are concerns with the use of PF and UF resins. Mainly, volatile organic compounds (VOCs) are generated during the manufacture and use of such adhesives. The concern regarding the effect of VOCs, especially formaldehyde, on human health has prompted the development of more environmentally acceptable adhesives. Additionally, PF and UF resins are, in part, petroleum derived products. Thus, the wood composite industry would benefit both economically and environmentally from the development of formaldehyde-free adhesives derived from non-petroleum sources.

Various formaldehyde-free adhesives for use in the composite and laminate wood industries have been developed and are based on combinations of a protein or lignin component in combination with a substantially formaldehyde-free curing agent that also provides adhesion promotion. For example, one commercially-employed formaldehyde-free adhesive for the wood industry is an adhesive system comprising a soy protein and a polyamidoamine-epichlorohydrin (PAE) resin.

However, the use of such formaldehyde-free adhesive formulations is not always ideal. One problem confronting the composite and laminate wood industry in use of such environmentally acceptable adhesives is the formation of color in plywood made with such PAE-soy adhesive systems. For example, when plywood is made with a hardwood surface veneer where the veneer comprises spliced lines bonded with a urea-formaldehyde adhesive, a dark purplish stain is often observed in the vicinity of splice line after the hardwood veneer is bonded to the underlying substrate containing the formaldehyde-free adhesive. The purplish staining along the splice line is very obvious and can give the appearance of feathering away from the splice line. Moreover, the staining can transfer to adjacent boards when the panels are stacked without complete cooling after the bonding of the veneer layer. The discoloring produced along the splice lines is aesthetically unsatisfactory to the consumer, thus significantly reducing the value of the panels, and the discoloring also reduces the economy of production for the industry.

While attempts have been made to reduce the problem of splice line staining by employing alternative adhesives for the production of hardwood veneer layers, the quality of splicing using non-urea formaldehyde resins with hardwood materials has been less than satisfactory.

Thus, adhesive compositions which satisfy the new environmental standards and are essentially formaldehyde-free, but which also do not result in the discoloration of the hardwood surface veneer panels spliced with formaldehyde-containing adhesives which are often necessary in such applications would be advantageous.

### BRIEF SUMMARY OF THE INVENTION

The present invention relates, in general, to the surprising discovery that the addition of a urea additive to various compositions used as wood adhesives which comprise substantially formaldehyde-free adhesion promoters and protein and/or lignin components, can reduce or visibly eliminate staining along hardwood veneer splice lines containing urea-formaldehyde resins.

One embodiment of the present invention includes a composition comprising: (a) a polymeric component selected from the group consisting of lignins, proteins, and mixtures thereof; (b) an adhesion promoter comprising at least one component selected from the group consisting of (i) adducts of an epoxide and a resin selected from the group consisting of polyamine resins, polyamidoamine resins, polyamide resins, and combinations thereof, and (ii) combinations of a curing agent and a compound having at least one amine, amide, imine, imide, or nitrogen-containing heterocyclic functional group capable of reacting with at least one functional group of the polymeric component; and (c) an additive selected from the group consisting of, urea, N-substituted ureas, N,N-disubstituted ureas, N,N′-disubstituted ureas, N,N,N′-trisubstituted ureas, N,N,N′,N′-tetrasubstituted ureas, urea derivatives, and mixtures thereof.

In various preferred embodiments of the present invention, the additive comprises urea, N-substituted ureas, N,N-disubstituted ureas, N,N′-disubstituted ureas, N,N,N′-trisubstituted ureas, N,N,N′,N′-tetrasubstituted ureas, or mixtures thereof. In certain more preferred embodiments of the present invention, the additive comprises urea.

Another embodiment of the present invention includes a composite structure comprising a compressed and cured mixture of (a) a plurality of cellulosic particles; and (b) a binder comprising a composition according to the present invention.

Another embodiment of the present invention includes a laminate product comprising: (a) a core material substrate having a surface, and (b) an outer veneer layer bonded to the surface with an adhesive disposed between the surface and the veneer layer, wherein the adhesive comprises a composition according to the present invention.

Yet another embodiment of the present invention includes a process comprising: (a) providing a core material substrate having a surface; (b) applying an adhesive to the surface of the substrate, wherein the adhesive comprises a composition according to the present invention; (c) disposing a hardwood surface layer on the adhesive-bearing surface of the substrate; and (d) curing the adhesive.

The use of compositions according to the present invention can provide significant economic benefits to plywood producers by allowing them to employ substrates and adhesives that are more environmentally acceptable and still prepare hardwood panels with UF-spliced surface veneers while avoiding undesirable staining.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which is presently preferred. It should be understood, however, that the invention is not limited to the precise arrangements and instrumentalities shown.

In the Figs.:

FIG. 1a shows the surface of a hardwood surface veneer plywood board in accordance with the prior art exhibiting staining along splice lines in the veneer layer;

FIG. 1b shows the surface of a hardwood surface veneer plywood board in accordance with one embodiment of the present invention exhibiting little or no staining along splice lines in the veneer layer; and

FIG. 1c shows the surface of a hardwood surface veneer plywood board in accordance with another embodiment of the present invention exhibiting little or no staining along splice lines in the veneer layer.

### DETAILED DESCRIPTION OF THE INVENTION

As used herein, the singular terms “a” and “the” are synonymous and used interchangeably with “one or more” or “at least one” unless the context clearly indicates a contrary meaning. Accordingly, for example, reference to “a compound” herein or in the appended claims can refer to a single compound or more than one compound. Additionally, all numerical values, unless otherwise specifically noted, are understood to be modified by the word “about.”

Compositions in accordance with the various embodiments of the present invention are suitable for use as an adhesive formulation or binder for preparing a composite wood product. As used herein, “composite wood product” can refer to either wood-particle construction materials or wood laminate construction materials, or both collectively. Wood-particle construction materials generally refer to cellulose-based materials prepared by compressing and curing mixtures of cellulosic particles and an adhesive formulation into a three-dimensional, rigid sheet, board, or other object having suitable structural integrity for use in construction applications. Cellulosic particles can include, but are not limited to, chips, flakes, strands, fibers, etc. Wood laminate construction materials generally refer to sheets, boards or other objects prepared by pressing two or more layers of wood or cellulosic materials together with adhesive between the layers.

Compositions in accordance with the present invention include a polymeric component selected from the group consisting of lignins, proteins, and mixtures thereof.

Any lignin can be employed as a polymeric component in a composition according to the invention. A lignin is generally understood as any of the complex, amorphous, three-dimensional polymers, which occur in plants, and that have in common a phenylpropane structure, that is, a benzene ring with a tail of three carbons. Suitable lignins can include industrial lignins, such as, for example, a Kraft lignin, and analytical lignin preparations. Suitable lignins are also described in U.S. Patent Application Publication No. 2004/0089418, the entire contents of which are hereby incorporated by reference herein.

Any protein can be employed as a polymeric component in a composition according to the invention. Suitable proteins can include, but are not limited to, vegetable proteins, blood meal, feather meal keratin, gelatin, collagen, gluten (wheat protein), zein (corn protein), whey protein and casein. A preferable vegetable protein is soy protein. Proteins suitable for use in accordance with the present invention are available commercially from a variety of sources and can be extracted from natural resources using techniques known in the art. Generally, proteins which are readily available from renewable resources are preferred. In various preferred embodiments of compositions according to the present invention, the polymeric component will comprise a soy protein. Suitable proteins are also described in U.S. Patent Application Publication No. 2004/0089418, which has been incorporated by reference.

Proteins used as a polymeric component in accordance with the present invention may be pretreated in any known manner to improve solubility, dispersibility and/or reactivity.

Various sources of soy protein can be used to provide a protein for use as a polymeric component in a composition according to the present invention. For example, suitable soy proteins can include soy flours (modified or unmodified), soy protein concentrates, and soy protein isolates. Soy flours having approximately 50% by weight protein on a dry basis can be used in various preferred embodiments. Soy protein concentrates having approximately 65% by weight protein on a dry basis can be used in various preferred embodiments. Soy protein isolates (SPI's) having at least approximately 85% by weight protein on a dry basis can be used in various preferred embodiments. Suitable soy proteins are available commercially from a number of sources, for example from Cargill, Inc. (Minneapolis, Minn.) and Archer Daniels Midland Co (Decatur Ill.), and can be extracted and modified via known techniques.

A polymeric component in accordance with the present invention can include combinations and mixtures of one or more lignins and one or more proteins. In various preferred embodiments of the present invention, a composition includes a polymeric component which comprises a soy protein.

Compositions in accordance with the present invention include an adhesion promoter. Suitable adhesion promoters in accordance with the present invention include: (i) adducts of an epoxide and a resin selected from the group consisting of polyamine resins, polyamidoamine resins, polyamide resins, and combinations thereof, (ii) combinations of a curing agent and a compound having at least one amine, amide, imine, imide, or nitrogen-containing heterocyclic functional group capable of reacting with at least one functional group of the polymeric component; and/or combinations thereof.

Adducts of epoxides and suitable resins which may be used as an adhesion promoter in compositions according to the present invention are described in U.S. Pat. No. 7,252,735, which has been incorporated by reference. In various preferred embodiments of the present invention, an adhesion promoter can comprise a polyamidoamie-epihalohydrin resin, and more preferably an epichlorohydrin resin. Such resins are known in the art and can be prepared by various polymer synthesis techniques known to those skilled in the art, and are also available commercially from a number of sources, such as, for example, Hercules Inc. (Wilmington, Del.).

Polyamidoamine-epihalohydrin resins can generally be prepared by a two-step process. First, a polyalkylenepolyamine is polycondensed with a polycarboxylic acid, for example, the reaction of diethylenetriamine (DETA) and adipic acid, to form a polyamidoamine. Second, the polyamidoamine is reacted with the epihalohydrin to produce the resin.

The first step, preparing the polyamidoamine, is well known and several methods are described in the art which allow control of molecular weight and structure. Suitable methods for preparing polyamidoamines are described, for example, in U.S. Pat. No. 5,786,429, U.S. Pat. No. 5,902,862, U.S. Pat. No. 6,222,006, U.S. Pat. No. 6,908,983 and U.S. Pat. No. 6,554,961, the entire contents of each of which is hereby incorporated by reference herein.

The reaction of a polyamidoamine and epihalohydrin is also well known and suitable preparative methods for forming polyamidoamine-epihalohydrin resins which can be used as an adhesion promoter in accordance with the present invention are described, for example, in U.S. Pat. No. 4,853,431, U.S. Pat. No. 5,019,606, U.S. Pat. No. 5,171,795, U.S. Pat. No. 5,189,142, U.S. Pat. No. 5,714,522, and U.S. Pat. No. 5,614,597, the entire contents of each of which is hereby incorporated by reference herein.

Another suitable type of polyamidoamine-epihalohydrin resin which can be used as an adhesion promoter in compositions according to the present invention comprises a low molecular weight (15,000-50,000 g/mol) resin which can be prepared by reacting conventional reactants, optionally employing monofunctional end-capping compounds, and controlling the temperature, pH and cook time of the reaction.

An adhesion promoter suitable for use in compositions according to the present invention can include combinations of a curing agent and a compound having at least one amine, amide, imine, imide, or nitrogen-containing heterocyclic functional group capable of reacting with at least one functional group of the polymeric component. Such combinations suitable for use in the present invention are described in, for example, U.S. Patent Application Publication No. 2004/0089418, which has been incorporated by reference.

The adhesion promoters of the present invention are preferably substantially formaldehyde-free. Moreover, the compositions of the present invention are preferably substantially formaldehyde-free. As used herein, “substantially formaldehyde-free” refers to compositions which comprise amounts of formaldehyde not significantly above, and preferably equal to or less than, environmental regulatory limits for formaldehyde. “Substantially formaldehyde-free” preferably refers to amounts of formaldehyde which are negligible in terms of environmental regulatory limits. Most preferably, “substantially formaldehyde-free” refers to amounts of formaldehyde that are not detectable by conventional analytical methods for quantitative analysis of formaldehyde.

The amount of polymeric component and the amount of adhesion promoter present in a composition according to the present invention can vary widely based on the particular wood materials being bonded together, the type of protein and/or lignin used and the physicochemical properties of the adhesion promoter. The weight ratio of polymeric component to adhesion promoter used in compositions according to the present invention can preferably be 100:1 to 0.1:1, more preferably 25:1 to 0.5:1 and most preferably 10:1 to 1:1.

One or more additives selected from the group consisting of urea, N-substituted ureas, N,N-disubstituted ureas, N,N,N-trisubstituted ureas, N,N,N,N-tetrasubstituted ureas, urea derivatives, and mixtures thereof can be incorporated in the compositions in accordance with the various embodiments of the present invention in any amount effective to reduce staining in the particular combination of substrate material and surface veneer layer material being used.

In some cases, depending on the particular hardwood(s) used in a given veneer layer and/or the particular wood materials used in a composite core or underlying substrate, additives other than urea, N-substituted urea, N,N-disubstituted urea, N,N,N-trisubstituted urea, N,N,N,N-tetrasubstituted urea, or mixtures thereof may not provide sufficient stain prevention. For example, when bonding a spliced maple veneer to a poplar substrate, biuret dimethyl hydantoin and allantoin did not provide significant stain prevention, yet these additives may each be effective for other wood combinations. Accordingly, in various preferred embodiments of the invention, the additive comprises a urea, N-substituted urea, N,N-disubstituted urea, N,N,N-trisubstituted urea, N,N,N,N-tetrasubstituted urea, or mixtures thereof. More preferably, the additive comprises urea. Most preferably, the additive consists essentially of urea.

The particular amount of additive necessary to reduce, or preferably eliminate, the staining along the splice lines of an outer hardwood veneer layer can vary depending upon the particular choice of material used as the veneer layer and the particular material of which the underlying substrate is comprised. As described in more detail in the Examples, particularly preferred amounts of additive which can be included in compositions of the present invention to satisfactorily reduce staining or visibly eliminate it altogether with respect to a particular combination of surface veneer material and underlying substrate material can be readily determined.

In general, suitable amounts of additive included in compositions in accordance with the various embodiments of the present invention can be 0.01 to 5% by weight, based on the total weight of the composition. More preferably, the amount of additive present in a composition according to the present invention can be 0.1 to 2.0% by weight, and more preferably 0.25 to 1.0% by weight, based on the total weight of the composition.

Suitable additives for inclusion in the compositions according to the various embodiments of the present invention include urea, substituted ureas and urea derivatives, as well as combinations thereof. The urea used in the compositions of the present invention can be technical grade, reagent grade, agricultural grade (i.e., feed grade or fertilizer grade). Suitable substituted ureas include mono-, di-, tri- and tetra-substituted ureas. Urea derivatives such as for example, thio-substituted ureas and hydrazides may also be suitable as additives for use with some types of wood, but not others. Examples of suitable substituted ureas and urea derivatives which may be used include, but are not limited to urea sulfate, urea phosphate, thiourea, methylurea, ethylurea, propylurea, butylurea, 1,1-dimethylurea, 1,3-dimethylurea, 1,3-diethylurea, 1,3-dipropylurea, 1,3-dioctadecylyurea, 1,3-dicyclohexylurea, hydroxyurea, 1-piperidinecarboxamide, bispentamethylene)urea, trimethylurea, triethylarea, tetramethylurea, tetraethylurea, 2-imidazolidone, 1,3-dimethyl-2-imidazolidinone, tetrahydro-2-pyrimidone, semicarbazide, carbohydrazide, thiocarbohydrazide, biuret, hydantoin, 1-methylhydantoin, 5,5-diemethylhydantion, allantoin, allantoic acid, 1,3-dimethyl-3,4,5,6-tetrahydro-2(1H)-pyrimidinone, parabinic acid, urazole, 6-amino-1,3-dimethyluracil, hydroorotic acid, 4-methylurazole, 5,6-dihydrouracil, barbituric acid, 1,3-dimethyobarbituric acid, 2,4-dioxohezahydro-1,3,5-triazine, and cyanuric acid.

Other ingredients may be included in compositions according to various embodiments of the invention, such as, for example, extenders, viscosity modifiers, defoamers, biocides, and fillers such as wheat flour, tree bark flour, nut shell flour and corn cob flour.

The components of a composition according to the invention are generally combined in a suitable mixer and are stirred until a homogeneous mixture is obtained. The compositions are typically prepared with solids contents of 5 to 75 wt. %, more preferably 10 to 60 wt. % and most preferably 20 to 50 wt. %.

The pH of a composition according to the invention can be adjusted, for example, to control the reactivity of an adhesion promoter. For example, polyamidoamine-epihalohydrin resins are more reactive in the neutral to alkaline region (pH 6-9) and adjusting the pH to this range will give increasing reactivity as the pH ranges from about 6 to about 9. At some point above pH 9, thermosetting reactivity is reduced due to competing reactions such as hydrolysis of azetidinium functionality and/or the polymer backbone. Also, the addition of urea to the adhesive formulation may cause the pH to increase. This may be adjusted by the addition of an appropriate acid, base or buffering agent to provide the best balance of reactivity and stability. Suitable acids for making pH adjustments are mineral acids such as sulfuric acid, phosphoric acid, phosphorous acid, hypophosphorous acid, nitric acid, hydrochloric acid, hydrobromic acid and hydroiodic acid. Organic acids such as formic acid, acetic acid, propionic acid, benzoic acid, methanesulfonic acid and p-toluenesulfonic acid are also suitable for making pH adjustments.

Additional embodiments of the invention also include compositions comprising a polymeric component or an adhesion promoter, in combination with an additive.

The present invention also includes composite structures comprising a compressed and cured mixture of (a) a plurality of cellulosic particles; and (b) a binder, wherein the binder comprises a composition according to the invention. The cellulosic particles can include, but are not limited to, wood chips, flakes, fibers, strands, etc. The resulting composite structure can include particle board, oriented strand board (OSB), waferboard, and fiberboard (including medium-density and high-density fiberboard) and other similar products. Compression and curing can be carried out in accordance with known parameters.

The present invention also includes laminate products comprising: (a) a core material substrate having a surface, and (b) an outer veneer layer bonded to the surface with an adhesive disposed between the surface and the veneer layer, wherein the adhesive comprises a composition according to the invention. The core material substrate can include a composite structure prepared using a binder containing a composition according to the present invention and/or other adhesive formulations. The core material can also or alternatively include a plurality of veneers, which can be of lower aesthetic quality than an outer surface veneer. The adhesive can be disposed on the surface of the core material substrate in any known manner, for example, as described in accordance with the methods of the present invention.

The present invention includes methods of preparing composite wood products. One embodiment of a method according to the present invention includes: (a) providing a core material substrate having a surface; (b) applying an adhesive to the surface of the substrate, wherein the adhesive comprises a composition according to the present invention; (c) disposing a hardwood surface layer on the adhesive-bearing surface of the substrate; and (d) curing the adhesive. Another embodiment of a method according to the present invention includes mixing a plurality of cellulosic particles and a binder comprising a composition according to the present invention, and curing the binder to form a composite structure.

Suitable core material substrate are described above. Hardwood surface layers can preferably include maple, cherry and birch veneers.

Compositions according to the present invention used in methods of the present invention are thermosetting materials and as such are cured by the application of heat and optionally, pressure. Typical temperatures for curing the adhesive compositions are in the range of 50 to 250° C., more preferably in the range of 80 to 200° C. and most preferably in the range of 100 to 150° C. Curing times at these temperatures can range from 30 seconds to one hour, more preferably from one minute to 30 minutes and most preferably from 2 minutes to 10 minutes.

The composition is preferably applied to a substrate surface in the range of 1 to 25% by weight, more preferably in the range of 1 to 10% by weight and most preferably in the range of 2 to 8% by weight. As stated previously the adhesive composition can be applied by the use of roller coating, knife coating, extrusion, curtain coating, foam coaters and spray coaters one example of which is the spinning disk resin applicator.

The adhesive composition may be applied onto veneer surfaces by roll coating, knife coating, curtain coating, or spraying. A plurality of veneers are then laid-up to form sheets of required thickness. The composed panel may then optionally be pressed at ambient temperature to consolidate the structure (cold pressing). This can be performed at a pressure from 25 to 250 psi for 1 to 10 minutes. The mats or sheets are then placed in a heated press (e.g., a platen) and compressed to effect consolidation and curing of the materials into a board. Hardwood plywood may also be manufactured by gluing a hardwood surface veneer to a substrate such as particle board, oriented strand board (OSB), waferboard, fiberboard (including medium-density and high-density fiberboard), parallel strand lumber (PSL), laminated strand lumber (LSL) and other similar products.

The present invention also includes methods of preparing laminate wood products having a hardwood surface veneer layer with UF splice lines in which the methods comprise providing an underlying substrate and affixing a hardwood surface veneer layer on a surface of the underlying substrate with an adhesive formulation comprising a polymeric component and/or an adhesion promoter, as those terms are described herein, wherein an additive, as described herein, is applied to a surface of the hardwood veneer layer in contact with the underlying substrate, an exposed surface of the hardwood veneer layer, or both, prior to curing the adhesive to form the laminate wood product. The additive can be applied to the surface or surfaces of the hardwood veneer layer, for example, by brushing or spraying an aqueous solution of the stain-reducing additive onto the surface of the hardwood veneer at any point of the manufacture before the panels are bonded to the underlying substrate.

The invention will now be described in further detail with reference to the following non-limiting examples.

### EXAMPLES

### Examples 1-6

### PAE-Soy-Urea Formulations

Samples of polyamidoamine-epichlorohydrin (“PAE”)/soy adhesive compositions were prepared with varied amounts of urea. A quantity of 33.75 g ChemVisions CA1000 Additive PAE resin (20% solids content), available from Hercules Inc., Wilmington Del., was diluted with 69.00 g dilution water. Example 1 was a comparative example in which no urea was added to the composition. In Examples 2 to 7, urea was added to the solution in the amounts noted in Table 1, and stirred until dissolved. To each solution was then added 47.25 g Prolia 100/90 soy flour available from Cargill Inc., Minneapolis Minn. while stirring. The mixture was stirred with a propeller-type stirrer at 60 rpm for 60 minutes. The pH and Brookfield viscosity of the adhesive compositions were measured and are listed in Table 1. The Brookfield viscosity was measured again at 24 hours and is also listed in Table 1.

TABLE 1
PAE/Soy Formulations With Added Urea

| | | | | Brookfield | |
|---|---|---|---|---|---|
| Example | g Urea | Wt. % | | Viscosity (cPs)* | |
| Number | Added | Urea | pH | Initial | 24 hrs. |
| 1 (comparative example) | 0.000 | 0.00 | 5.85 | 155,000 | 244,000 |
| 2 | 0.015 | 0.01 | 6.14 | 139,000 | 293,000 |
| 3 | 0.075 | 0.05 | 6.17 | 145,000 | 335,000 |
| 4 | 0.150 | 0.10 | 6.77 | 165,000 | 352,000 |
| 5 | 0.750 | 0.50 | 7.92 | 232,000 | 687,000 |
| 6 | 1.500 | 1.00 | 8.36 | 460,000 | 837,000 |
| 7 | 3.000 | 2.00 | 8.85 | 284,000 | 732,000 |

*Measured with a Brookfield DV-E viscometer at 23° C. using a #7 spindle at 3.0 rpm.

Addition of urea to the soy flour/PAE resin formulation results in a rise in pH. This is a well-documented phenomenon and is believed to be due to the presence of the enzyme urease in soy flour. This enzyme catalyzes the breakdown of urea to one mole of carbon dioxide and two moles of ammonia. The pH increases as a result of the ammonia generated by this reaction. There was no noticeable smell of ammonia in the samples prepared at added urea levels of below 1.0%. At the 1.0% level a slight ammonia smell was detectable and at a 2.0% urea level the ammonia smell was more noticeable.

There was no significant change in viscosity of the formulations until a urea level of 0.5% is reached. At that point the viscosity showed a distinct upward trend. Although the viscosity of all the formulations had increased at 24 hours, all of the adhesive formulations were flowable at this point. It should be possible to formulate a PAE/soy adhesive composition that contains a sufficient amount of urea to prevent staining while also having good pH and viscosity stability. Adjustment of the pH with other additives such as acids or buffering agents to achieve optimal stability may be undertaken if desired.

### Examples 8-12

### PAE-Soy-Urea Formulations

Samples of PAE/soy adhesives were prepared with varied amounts of urea. A quantity of 31.88 g ChemVisions CA1000 Additive PAE resin (20% solids content), available from Hercules Inc., Wilmington Del., was diluted with 73.5 g dilution water. To each sample was added 1.50 g of urea. To each urea-containing solution was then added 44.63 g Prolia 100/90 soy flour available from Cargill Inc., Minneapolis Minn. while stirring. The mixtures were then stirred with a propeller-type stirrer at 600 rpm for 60 minutes. The pH of the adhesive mixtures was adjusted to different pH values using either concentrated sulfuric acid or concentrated phosphoric acid, the quantities of which are listed in Table 2 with the final pH values. The Brookfield viscosity of the adhesive formulations were measured and are listed in Table 2. The Brookfield viscosity was measured again at 24 hours and is also listed.

TABLE 2
Formulations of PAE/Soy with added Urea

| Exam- | | Wt. | | | | Brookfield | |
|---|---|---|---|---|---|---|---|
| ple | g Urea | % | g Added | Initial | pH @ | Viscosity (cPs)* | |
| Number | Added | Urea | Acid | pH | 24 hrs. | Initial | 24 hrs. |
| 8 | 1.500 | 1.00 | 0 | 8.76 | 8.33 | 407,000 | 579,000 |
| 9 | 1.500 | 1.00 | 1.1 Sulf. | 6.99 | 7.21 | 199,000 | 420,000 |
| 10 | 1.500 | 1.00 | 2.2 Sulf. | 6.02 | 6.20 | 191,000 | 276,000 |
| 11 | 1.500 | 1.00 | 1.5 Phos. | 6.97 | 6.90 | 203,000 | 416,000 |
| 12 | 1.500 | 1.00 | 5.2 Phos. | 5.99 | 5.96 | 219,000 | 269,000 |

*Viscosity measured using a Brookfield DV-E viscometer with a #7 spindle at 3.0 rpm and 23° C.

### Examples 13-15

### Preparation of Hardwood Plywood Panels

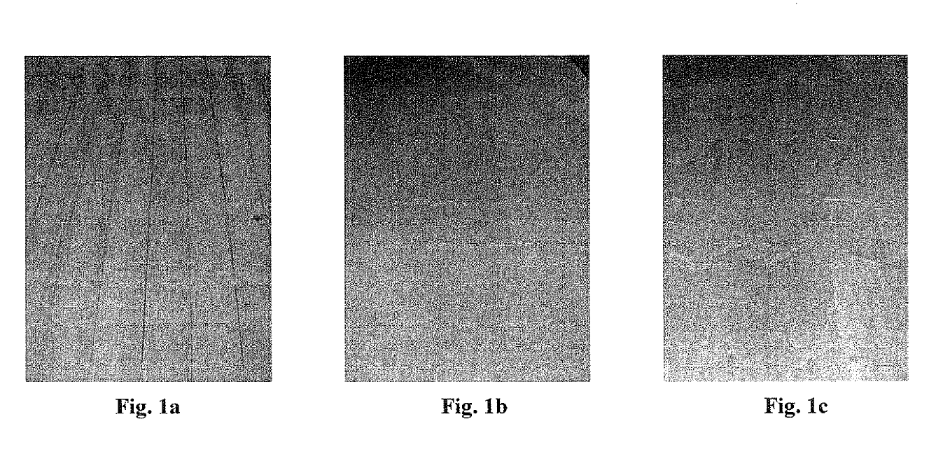

A master batch of soy/PAE adhesive was prepared by mixing 33 pounds of water with 17 pounds of Hercules CA1000 additive (20% solids content), available from Hercules Inc., Wilmington Del., and 25 pounds of Prolia 100/90 soy flour, available from Cargill Inc., Minneapolis Minn. The CA1000 additive and water were combined in a cement mixer and the soy flour was poured in while mixing. Once the soy flour was all added the formulation was mixed for 30 minutes. From this master batch, three aliquots of 3,180 g were removed and were combined with different amounts of urea as shown in Table 3. The urea was added to the aliquots of Example 8 and Example 9 in separate 5 gallon pails and the mixtures were stirred with a hand held drill with a paddle type stirrer. The urea used was reagent grade material (98% pure) obtained from Aldrich Chemical Company, Milwaukee Wis. These experimental samples were then each applied to three sets of two 4′×4′ poplar panels of 5/16″ thickness with a medium nap paint roller. When the panels were coated with the adhesive mixture, they were applied to three separate 4′×8′ pieces of maple veneer having numerous splice lines that were glued together with urea-formaldehyde (UF) resin. The two coated poplar panels of each set were placed to orient the grain of the maple perpendicular to the grain of the poplar. The other side of each of the three sets of poplar panels was then coated with the respective experimental adhesive formulation and another sheet of maple veneer was placed on top. The panels were then pressed for 4 minutes under a pressure of 100 psi at ambient temperature (cold pressing). Following this cold pressing step the panels were cured in a heated press for 8 minutes at 255° and 175 psi. The panels were examined for staining at the splice line when they were removed from the hot press. Staining was apparent in the control panel of Example 13 as shown in FIG. 1a, but was not visible in the panel that contained 0.5% urea (Example 14), as shown in FIG. 1b, or in the panel that contained 2.0% urea (Example 15), as shown in FIG. 1c.

TABLE 3
Preparation of Panels (Examples 13-15)

| Example | | Amount | | Staining |
|---|---|---|---|---|
| Number | Additive | Added | pH | Present |
| 13 | None (comparative example) | 0 | 6.07 | Yes |
| 14 | 0.5% Urea | 15.9 g | 7.63 | No |
| 15 | 2.0% Urea | 63.6 g | 9.16 | No |

### Examples 16-19

Another set of panels was made in a similar manner as Examples 13-15. The adhesive formulations used and the results are shown in Table 4. In this set of experiments reagent grade urea was added at 0.1%, 0.25% and 0.5% levels. These panels were cold pressed for 4 minutes at ambient temperature at a pressure of 100 psi and were cured at 255° F. for 7 minutes at 175 psi. The control panel (Example 16, no added urea) and the panel with 0.1% urea (Example 17) showed distinct staining along the maple splice lines. The 0.25% urea level (Example 18) showed a slight stain and the 0.5% urea level (Example 19) showed no evidence of staining along the splice lines

TABLE 4
Preparation of Panels (Examples 16-19)

| Example | | Amount | | |
|---|---|---|---|---|
| Number | Additive | Added (g) | pH | Staining |
| 16 | None (comparative example) | 0.0 | 6.10 | Yes |
| 17 | 0.1% Urea | 3.2 | 6.35 | Yes |
| 18 | 0.25% Urea | 7.9 | 6.75 | Slight |
| 19 | 0.5% Urea | 15.9 | 7.62 | No |

### Examples 20-26

Additional panels were prepared in a similar manner as Examples 13-15. The adhesive formulations used and the results are shown in Table 5. This work was performed with reagent grade urea from Aldrich and with an agricultural grade (AG) urea obtained from C&C Chemical, Asheville N.C. These panels were cold pressed for 4 minutes at ambient temperature and 100 psi. They were then cured at 255° F. for 7 minutes at 175 psi. The conditions and results of testing are shown in Table 5. Staining was apparent in the control sample (Example 20) and with a urea level of 0.1% (Example 21). A noticeable but slight amount of staining was observed when 0.25% urea was added, either as reagent grade urea (Example 22) or as agricultural grade urea (Example 25). At an addition level of 0.5%, no staining was seen using either reagent grade urea (Example 23) or using agricultural grade urea (Example 26). At a level of 1.0% reagent grade urea no staining was observed (Example 24).

TABLE 5
Examples 20-26

| Example | | Amount | | Staining |
|---|---|---|---|---|
| Number | Additive | Added (g) | pH | Present |
| 20 | None (comparative example) | 0.0 | 6.10 | Yes |
| 21 | 0.1% Urea | 3.2 | 6.35 | Yes |
| 22 | 0.25% Urea | 7.9 | 6.75 | Slight |
| 23 | 0.5% Urea | 15.9 | 7.74 | No |
| 24 | 1.0% Urea | 31.8 | 8.64 | No |
| 25 | 0.25% AG Urea | 7.9 | 6.96 | Slight |
| 26 | 0.5% AG Urea | 15.9 | 7.62 | No |

The preceding examples show that a level of urea of about 0.5% is effective in preventing stain formation of hardwood plywood prepared with a PAE/soy adhesive and with a surface maple veneer that has a UF splice glue. It is believed that this should generally be an effective level of urea to use in this application, however, when using different conditions, different acceptable stain thresholds, and different wood sources for making hardwood plywood panels the effective level of urea may be higher or lower than this value.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A composition comprising:
(a) a polymeric component selected from the group consisting of lignins, proteins, and mixtures thereof;
(b) an adhesion promoter comprising at least one component selected from the group consisting of (i) adducts of an epoxide and a resin selected from the group consisting of polyamine resins, polyamidoamine resins, polyamide resins, and combinations thereof and (ii) combinations of a curing agent and a compound having at least one amine, amide, imine, imide, or nitrogen-containing heterocyclic functional group capable of reacting with at least one functional group of the polymeric component; and
(c) an additive selected from the group consisting of urea, N-substituted ureas, N,N-disubstituted ureas, N,N′-disubstituted ureas, N,N,N′-trisubstituted ureas, N,N,N′,N′-tetrasubstituted ureas, urea derivatives, and mixtures thereof.

2. The composition according to claim 1, wherein the additive is selected from the group consisting of urea, N-substituted ureas, N,N-disubstituted ureas, N,N′-disubstituted ureas, N,N,N′-trisubstituted ureas, N,N,N′,N′-tetrasubstituted ureas, and mixtures thereof.

3. The composition according to claim 2, wherein the additive is present in an amount of 0.01 to 5% by weight, based on the composition.

4. The composition according to claim 2, wherein the composition is present as an aqueous mixture having a solids content of 5 to 75% by weight, based on the mixture.

5. The composition according to claim 2, wherein the adhesion promoter comprises a polyamidoamine-epichlorohydrin resin.

6. The composition according to claim 3, wherein the adhesion promoter comprises a polyamidoamine-epichlorohydrin resin.

7. The composition according to claim 2, wherein the polymeric component comprises a protein.

8. The composition according to claim 2, wherein the polymeric component comprises a soy protein.

9. The composition according to claim 5, wherein the polymeric component comprises a soy protein.

10. The composition according to claim 6, wherein the polymeric component comprises a soy protein.

11. The composition according to claim 2, wherein the polymeric component comprises a soy protein isolate having at least about 85% by weight protein.

12. The composition according to claim 2, wherein the polymeric component comprises soy flour.

13. The composition according to claim 2, wherein the additive comprises urea.

14. The composition according to claim 9, wherein the additive comprises urea.

15. The composition according to claim 10, wherein the additive comprises urea.

16. The composition according to claim 2, wherein the additive is present in an amount of 0.1 to 2% by weight based on the composition.

17. The composition according to claim 2, wherein the adhesion promoter comprises a polyamidoamine-epichlorohydrin resin, wherein the polymeric component comprises a soy protein, wherein the additive comprises urea, and wherein the urea is present in an amount of 0.1 to 2% by weight, based on the composition.

18. A composite structure comprising a compressed and cured mixture of (a) a plurality of cellulosic particles; and (b) a binder, wherein the binder comprises the composition according to claim 1.

19. A composite structure comprising a compressed and cured mixture of (a) a plurality of cellulosic particles; and (b) a binder, wherein the binder comprises the composition according to claim 2.

20. A laminate product comprising: (a) a core material substrate having a surface, and (b) an outer veneer layer bonded to the surface with an adhesive disposed between the surface and the veneer layer, wherein the adhesive comprises the composition according to claim 1.

21. A laminate product comprising: (a) a core material substrate having a surface, and (b) an outer veneer layer bonded to the surface with an adhesive disposed between the surface and the veneer layer, wherein the adhesive comprises the composition according to claim 2.

22. The laminate product according to claim 21, wherein the core material sheet comprises a composite structure comprising a compressed and cured mixture of (a) a plurality of cellulosic particles; and (b) a binder, wherein the binder comprises a composition comprising:
(a) a polymeric component selected from the group consisting of lignins, proteins, and mixtures thereof;
(b) an adhesion promoter comprising at least one component selected from the group consisting of (i) adducts of an epoxide and a resin selected from the group consisting of polyamine resins, polyamidoamine resins, polyamide resins, and combinations thereof, and (ii) combinations of a curing agent and a compound having at least one amine, amide, imine, imide, or nitrogen-containing heterocyclic functional group capable of reacting with at least one functional group of the polymeric component; and
(c) an additive selected from the group consisting of amides, urea, N-substituted ureas, N,N-disubstituted ureas, N,N′-disubstituted ureas, N,N,N′-trisubstituted ureas, N,N,N′,N′-tetrasubstituted ureas, urea derivatives, and mixtures thereof.

23. A process comprising: (a) providing a core material substrate having a surface; (b) applying an adhesive to the surface of the substrate, wherein the adhesive comprises a composition according to claim 1; (c) disposing a hardwood surface layer on the adhesive-bearing surface of the substrate; and (d) curing the adhesive.

24. A process comprising: (a) providing a core material substrate having a surface; (b) applying an adhesive to the surface of the substrate, wherein the adhesive comprises a composition according to claim 2; (c) disposing a hardwood surface layer on the adhesive-bearing surface of the substrate; and (d) curing the adhesive.
